(19) United States
(12) Patent Application Publication
(10) Pub. No.: US 2008/0295899 A1
(43) Pub. Date: Dec. 4, 2008

(54) COMPRESSED GAS REGULATOR

(75) Inventor: Danial Scott Jones, Loyalhanna, PA (US)

Correspondence Address: SIMPLE IP LAW, P.C., 9600 SW OAK STREET., SUITE 525, TIGARD, OR, 97223, US

(73) Assignee: SMART PARTS, INC., Loyalhanna, PA (US)

(21) Appl. No.: 11/755,471

(22) Filed: May 30, 2007

(51) Int. Cl. F16K 31/12

(52) U.S. Cl. 137/505.18

(57) ABSTRACT

A compressed gas regulator preferably includes a body having a piston chamber and an output port. A regulator piston can be arranged in the piston chamber with a first surface being acted upon by pressurized gas having the output pressure. A second surface of the piston can be acted upon by a biasing member, such as a spring or spring pack. The biasing member supplies a biasing force that urges the piston toward a first position. The output pressure of the pressurized gas acting on the first surface creates a force that urges the piston toward a second position. A piston seal is preferably arranged on an end of the piston stem to seat against and seal off an inlet port when the piston is in the second position. A pressure adjustment member can be configured to adjust the amount of biasing force applied by the biasing member on the second piston surface. A plug can provide the inlet port, with a stop ring retaining the plug in place to prevent over-pressurization. For CO₂ applications, the compressed gas regulator can also include an expansion chamber and a bleed valve. A swivel connector can surround an end of the pressure adjustment member and connect to a source of compressed gas.

### BACKGROUND OF THE INVENTION

1. Field of the Invention

This invention relates generally to regulators (and their operating components) for regulating an output pressure of compressed gas such as CO₂, compressed air, nitrogen, or other compressed gas. More particularly, this invention relates to a compressed gas regulator for regulating an output pressure of a compressed gas for use in pneumatic applications, such as a pneumatic paintball gun or other pneumatic device.

2. Related Art

In pneumatic applications, and particularly pneumatic paintball guns, it is generally desirable to have a compressed gas regulator that is as simple and easy to maintain as possible, while providing all the benefits that operators desire. The regulator must, for instance, be able to provide a steady supply of compressed gas at a stable output pressure. Fluctuations in the output pressure of the compressed gas during operation are undesirable as they may result in faulty operation of a connected pneumatic device. In paintball guns in particular, fluctuations in the output pressure of the regulator may result in velocity spikes and/or shoot down. Velocity spikes may cause the paintball gun to exceed the allowable firing velocity and subject a player to penalties or elimination. Shoot down may result in a player not being able to maintain a high rate of fire and may substantially decrease the accuracy of the paintball gun and the player's ability to eliminate opponents. It is desirable, therefore, to have a regulator that is able to maintain a steady and reliable output pressure with a minimal number of components.

FIGS. 1, 2A, and 2B are somewhat schematic cross-sectional side views of conventional compressed gas regulators for paintball guns. Conventional regulators may lack flexibility in their mounting orientation with respect to an attached device and/or a compressed gas source. Referring to FIG. 1, for instance, the orientation of a conventional regulator 100 with respect to an attached device (not shown) may be dependent on the orientation of the threads (e.g., ASA threads) that provide the connection mechanism 102. When the compressed gas input port 106 is arranged on a side of the regulator body 101, for instance, the orientation of the input port 106 of the conventional regulator 100 is dependent on the threaded connection with the pneumatic device.

Accordingly, in cases where the orientation of the compressed gas connection is fixed with respect to the regulator body, the required orientation of the regulator with respect to the pneumatic device can result in the need for longer connection hoses or tubes for connecting to the compressed gas source. This can further result in inconvenience for the operator who must work around those hoses or tubes.

A conventional solution to this problem, as shown in FIGS. 2A and 2B, is to arrange the compressed gas input port (e.g., ⅛ NPT) 206 at the bottom 200B of the regulator 200 rather than the side. A separate swivel fitting 290 can then be provided in the input port 206 to facilitate adjustment of the orientation of the connection to the compressed gas source. It would be desirable, however, to have a regulator that provides integrated flexibility with respect to an orientation of a connection to a compressed gas source.

Referring still to FIGS. 2A and 2B, the conventional regulator 200 shown includes a regulator body 201 having an output end 200A with a threaded ASA connection 202. A separate body cover (sleeve) 295 can be provided to house the body 201 for better ergonomics, aesthetics, and safety. A piston chamber 216 is arranged in the body 201 with an output area 216A communicating with an output port 204 arranged at the output end 200A of the regulator body 200. A piston 240 is arranged in the piston chamber 216 with a first surface 242 arranged in communication with the output area 216A. A spring 250 is also arranged in the piston chamber 216 and acts on a second surface 244 of the piston 240 to bias the piston 240 toward the output end 200A of the regulator body 200.

A pressure adjustment screw 260 is arranged in an input end 200B of the regulator body 201. A spring platform 265 is arranged above the pressure adjustment screw 260 to provide a platform for the spring 250. The pressure adjustment screw 260 includes the compressed gas source connection port (input port) 206 and also provides an inlet port 274 arranged in a receptacle 262 of the pressure adjustment screw 260. The inlet port 274 receives compressed gas from the input port 206 through a gas transfer passageway 272 and supplies compressed gas into the receptacle 262. The piston 240 includes a stem 246 that extends through a center of the spring 250 and into the receptacle 262 of the pressure adjustment screw 260. A piston seal 249 is arranged on an end of the piston stem 246. A gas transfer passage 248 extends through the stem 246 from a stem port 247 arranged through a side of the stem 246 to the output area 216A of the piston chamber 216.

In operation, the spring 250 applies a biasing force oil the second piston surface 244 that biases the piston 240 towards a first position, with the piston seal 249 disposed away from the inlet port 274 of the pressure adjustment screw 260. In this position, compressed gas from the input port 206 is permitted to travel through the inlet port 274 into the receptacle 262 and through the gas transfer passageway 248 in the piston stem 240 into the output area 216A.

When an output pressure in the output area 216A of the piston chamber 216 reaches a predetermined level, it creates a sufficient force on the first surface 242 of the piston 240 to overcome the biasing force of the spring 250, and the piston 240 moves toward the input end 200B of the regulator 200. When the piston reaches a second position, the piston seal 249 contacts a surface surrounding the inlet port 274 and thereby closes off the inlet port 274 to prevent further compressed gas from the compressed gas source from entering the piston chamber 216.

The output pressure can be adjusted using the pressure adjustment screw 260. More specifically, tightening the pressure adjustment screw 260 causes the spring platform 265 to compress the spring 250, thereby increasing the amount of biasing force applied by the spring 250 on the second piston surface 244. Loosening the pressure adjustment screw 260 relieves the compression of the spring 250 and decreases the amount of biasing force applied by the spring 250 on the piston 240. The greater the biasing force applied to the piston 240 by the spring 250, the greater the output pressure required to seat the piston seal 249 against the inlet port 274.

CO₂ provides a readily available and inexpensive source of compressed gas for pneumatic applications. Unfortunately, conventional regulators may lack the ability to operate reliably and consistently using CO₂ as the compressed gas source. It would further be desirable, therefore, to have a regulator that provides the ability to reliably use CO₂ as the compressed gas source. The industry is in need of a compressed gas regulator that provides some or all of these benefits and advantages.

### SUMMARY OF THE INVENTION

According to principles of the present invention, a compressed gas regulator for a pneumatic device (such as a paintball gun, for example), can include a body. The body can include an output end having a connector (e.g., a standard ASA thread) for connecting to the pneumatic device. The opposite end of the body can be provided with a swivel connector for connecting to a compressed gas source. The swivel connector can include, for instance, a standard ⅛ NPT threaded input port for receiving a tube connector.

The body of the compressed gas regulator preferably includes a piston chamber and an output port for supplying compressed gas having an output pressure to the connected device. A regulator piston can be arranged in the piston chamber with a first surface being acted upon by pressurized gas having the output pressure. A second surface of the piston can be acted upon by a biasing member, such as a spring or spring pack. The biasing member supplies a biasing force that urges the piston toward a first position. The output pressure of the pressurized gas acting on the first surface creates a force that urges the piston toward a second position.

A stem of the piston can be arranged through a center of the biasing member toward an inlet port. A gas transfer passage is preferably arranged through the piston stem to communicate compressed gas from the inlet port to the piston chamber output area located proximal to the first surface when the piston is in the first position (the “first position” can, for instance, refer to any position other than the second position). A piston seal is preferably arranged on an end of the piston stem to seat against and seal off the inlet port when the piston is in the second position.

A pressure adjustment member can be arranged in communication with the biasing member (either directly or through intermediate members) to adjust the amount of biasing force applied by the biasing member on the second piston surface. By adjusting the amount of biasing force, the amount of pressure required to seal off the inlet port can be adjusted and the output pressure can thereby be controlled. The pressure adjustment member can include a receptacle that matingly receives the end of the piston stem having the piston seal.

A plug can also be arranged in the receptacle and can supply the inlet port and an inlet port seat surrounding the inlet port. The plug preferably includes one or more passageways that receive compressed gas from the compressed gas source and communicate the compressed gas to the inlet port. A stop ring can be provided to prevent the plug (and inlet port seat) from inadvertently being withdrawn or removed from the receptacle, and thereby prevent regulator overpressurization that would result from bottoming out of the spring pack and separation of the inlet port seat from the piston seal.

In operation, compressed gas is preferably received into the regulator body via the input port in the swivel connector. Compressed gas from the swivel connector is then supplied to the plug through one or more passageways in a sidewall of the pressure adjustment member. The plug receives the compressed gas into the plug body and transmits the compressed gas to the inlet port through one or more passageways.

If the output pressure is below a predetermined threshold, the force of the output pressure on the first surface of the piston is insufficient to counteract the biasing force of the biasing member on the second surface, and the piston is urged toward a first position. In this case, compressed gas from the inlet port is permitted to enter the receptacle in the pressure adjustment member and travel into and through the gas transfer passage in the piston stem to the piston chamber output area in communication with the first surface. Compressed gas travels from the output area to the output port.

Once the output pressure in the output chamber reaches the desired level, the force created by the output pressure on the first piston surface overcomes the biasing force of the biasing member and forces the piston into the second position. In the second position, the piston seal arranged on the end of the piston stem seals off the inlet port and prevents additional compressed gas from entering the gas transfer passage in the piston stem. In this manner, the compressed gas regulator maintains the output pressure in the output chamber. The pressure adjustment member is used to set the output pressure by adjusting the amount of the biasing force applied by the biasing member on the second piston surface.

According to additional principles of the present invention, the body of the compressed gas regulator can also include an expansion chamber for use in CO₂ applications. A bleed valve can be arranged in communication with the expansion chamber to release liquid CO₂ from the regulator and prevent liquid CO₂ from being supplied to an attached pneumatic device. The expansion chamber can be formed in a fluid path between the output area of the piston chamber and the output port, and preferably allows the expansion of the CO₂ into its gaseous state. The bleed valve is preferably arranged at a bottom of the expansion chamber. If liquid CO₂ remains after the expansion process, the bleed valve permits the liquid CO₂ to be expelled from the regulator body. More particularly, above a certain pressure, the pressurized gas and liquid CO₂ in the expansion chamber force the bleed valve open. Since the liquid CO₂ is more dense than the gaseous CO₂, the liquid CO₂ is forced out of the open bleed valve and released from the regulator. A slot can be arranged in the side of the regulator to prevent a pinpoint exhaust of pressurized gas or CO₂ from penetrating the skin of an operator's hand.

According to a still further aspect of the present invention, a pressure relief port can be provided through a sidewall of the regulator body in communication with the piston chamber at a predetermined location. If the pressure on the output side of the regulator piston exceeds an acceptable amount, the piston will be forced past the pressure relief port and the compressed gas will be safely released from the regulator body. The pressure relief port can communicate with a slot arranged along a side of the regulator body to prevent a pinpoint exhaust of compressed gas. In a CO₂ embodiment, the slot arranged in the side of the regulator to communicate with the bleed valve exhaust can also communicate with this pressure relief port. Alternatively, a separate slot could be provided.

Various other aspects, embodiments, and configurations of this invention are also possible without departing from the principles disclosed herein. This invention is therefore not limited to any of the particular aspects, embodiments, or configurations described herein.

### BRIEF DESCRIPTION OF THE DRAWINGS

The foregoing and additional objects, features, and advantages of the present invention will become more readily apparent from the following detailed description of preferred embodiments, made with reference to the accompanying figures, in which:

FIG. 1 is a somewhat schematic cross-sectional side view of a conventional compressed gas regulator for a pneumatic device;

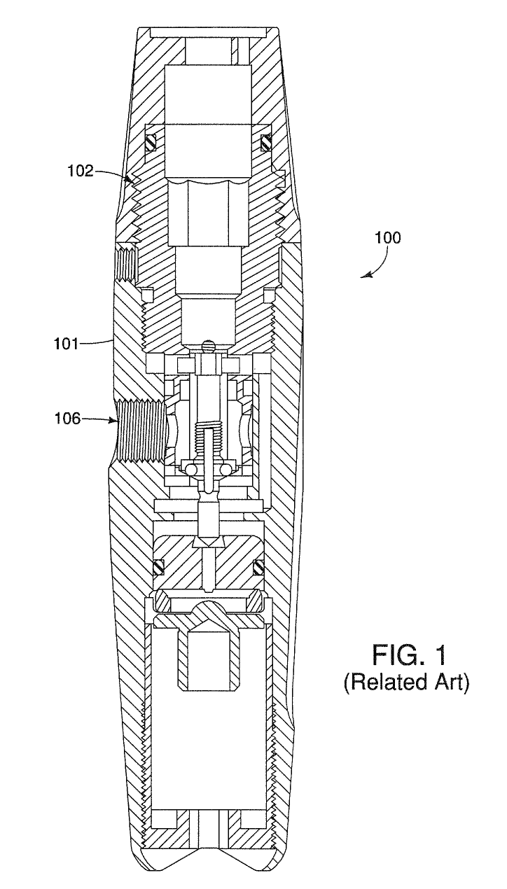

FIG. 2A is a somewhat schematic cross-sectional side view of another conventional compressed gas regulator for a pneumatic device;

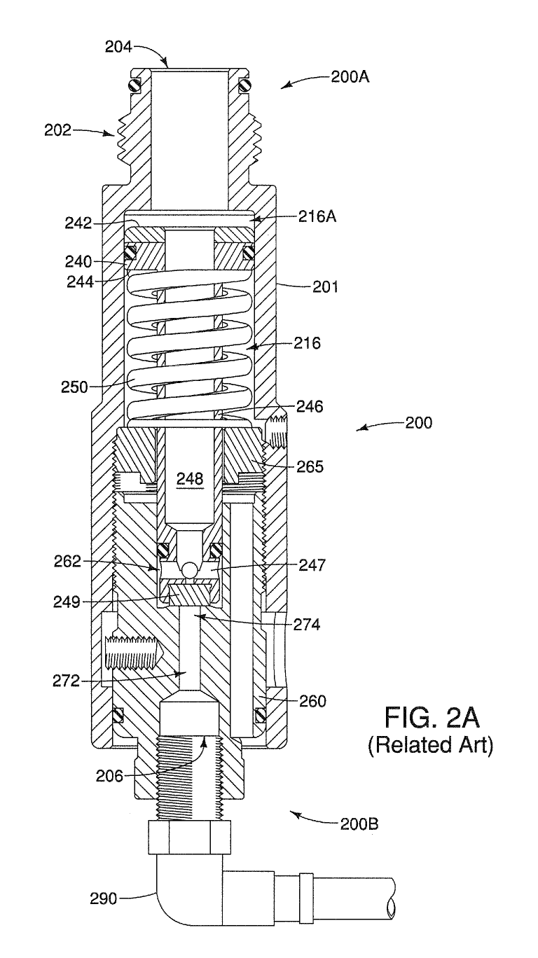

FIG. 2B is a somewhat schematic exploded side view of the conventional compressed gas regulator of FIG. 2A; and

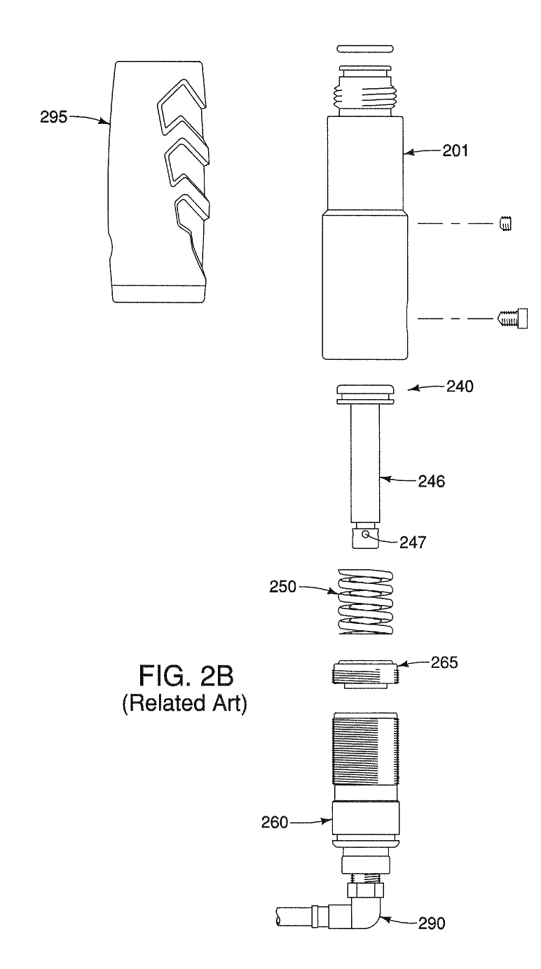

FIG. 3 is a somewhat schematic cross-sectional side view of a compressed gas regulator constructed according to one embodiment incorporating principles of the present invention.

### DETAILED DESCRIPTION

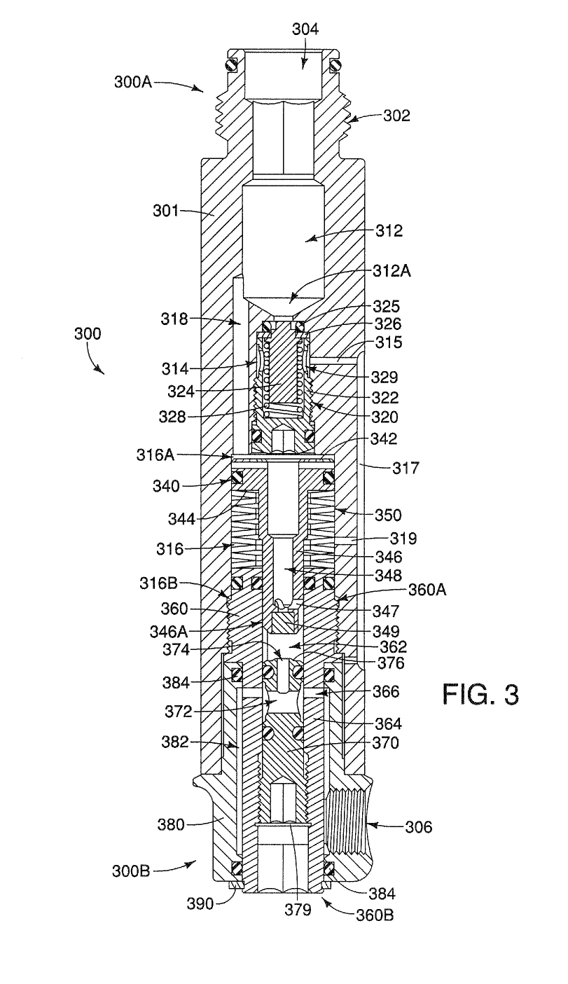

Various principles and aspects of the present invention will now be described in detail with reference to the accompanying drawings. Specifically, FIG. 3 is a cross-sectional side view of a compressed gas regulator 300 constructed according to principles of the present invention. Referring to FIG. 3, a compressed gas regulator 300 preferably includes a body 301 with an output end 300A having an output port 304 and an input end 300B having an input port 306. The output end 300A can include a connection mechanism 302 (e.g., standard ASA threads) to enable connection with a pneumatic device (e.g. a paintball gun).

For CO₂ applications, an expansion chamber 312 is preferably arranged in the regulator body 301 in fluid communication with the output port 304. A bleed valve 320 can be arranged in a bleed valve chamber 314 arranged in communication with a bottom area 312A of the expansion chamber 312.

The bleed valve 320 preferably comprises a valve body 322. A valve piston 324 is preferably arranged in the valve body 322 and biased in a closed position against a valve seat 326 and sealing member 325 through a biasing force applied to the piston 324 by a spring 328. One or more outlet ports 329 are preferably arranged through the valve body 322. An exhaust port 315 can also be provided through a sidewall of the regulator body 301 to release all exhaust from the outlet ports 329. A slot 317 can be arranged along the side of the regulator body 301 in communication with the exhaust port 315 to allow expansion of the exhaust and prevent a pinpoint exhaust of compressed gas or liquid CO₂ from contacting a user's hand.

A piston chamber 316 is also preferably arranged in the regulator body 301 with a gas transfer passage 318 providing fluid communication with the expansion chamber 312. A piston 340 is preferably arranged in the piston chamber 316 and has a first surface 342, a second surface 344, and a piston stem 346. A compressed gas transfer passage 348 is arranged through the piston 340 and communicates with a stem port 347 arranged near an end 346A of the piston stem 346. The first surface 342 of the piston 340 is preferably arranged in an output area 316A of the piston chamber 316. A biasing member 350 (e.g., a spring, spring pack, or other biasing member) is preferably arranged in the piston chamber 316 to apply a biasing force to the second surface 344. The piston stem 346 can extend through a center of the biasing member 350 and into a receptacle 362 of a pressure adjustment mechanism 360. A piston seal 349 is preferably arranged on or in the end 346A of the piston stem 346.

The pressure adjustment mechanism 360 can be arranged in an end 316B of the piston chamber 316 opposite the output area 316A. The pressure adjustment mechanism 360 preferably communicates with the biasing member 350 to enable adjustment of an amount of biasing force applied by the biasing member 350 on the second surface 344 of the piston 340. For instance, the pressure adjustment mechanism 360 may have threads arranged on a first end 360A to be threaded into the piston chamber 316 in contact with the biasing member 350. In this case, advancing the threads (e.g., through clockwise rotation) of the pressure adjustment mechanism 360 can increase a biasing force applied by the biasing member 350 on the piston 340 by compressing the biasing member 350. Unthreading the pressure adjustment mechanism 360 can reduce the biasing force.

A plug 370 can be arranged inside the receptacle 362 of the pressure adjustment mechanism 360. One or more passageways 366 can be arranged through a sidewall 364 of the pressure adjustment mechanism 360 to transmit gas into the receptacle 362. The plug 370 preferably includes one or more gas transfer passageways 372 that receive compressed gas from the passageways 366 and communicate the compressed gas to the inlet port 374. An inlet port seat 376 surrounds the inlet port 374. A stop ring 379 is preferably provided to prevent the plug 370 (and inlet port seat 376) from inadvertently being withdrawn from the receptacle 362. The stop ring 379 thereby helps prevent regulator overpressurization that might otherwise result from bottoming out of the spring pack 350 and separation of the inlet port seat 376 from the piston seal 349.

A second end 360B of the pressure adjustment mechanism 360 can extend through the input end of the body 301. A swivel connector 380 can be arranged around the second end 360B of the pressure adjustment mechanism 360. An internal chamber 382 of the swivel connector preferably surrounds the pressure adjustment mechanism 360 and communicates compressed gas from the input port 306 to the passageways 366. The input port 306 is preferably capable of being rotated around the pressure adjustment mechanism 360. In this embodiment, the swivel connector permits complete, 360° rotation of the input port 306 around the pressure adjustment mechanism 360. The input port 306 can, for instance, provide a standard ⅛ NPT fitting connection. A snap ring 390 can be provided on the second end 360B of the pressure adjustment mechanism 360 to retain the swivel connector 380 on the pressure adjustment mechanism 360.

In operation, compressed gas having an input pressure is received from a compressed gas source (not shown) into the swivel connector 380 of the compressed gas regulator 300 through the input port 306. Seals 384 prevent compressed gas from escaping from the swivel connector 380 in an undesired direction. The compressed gas in the swivel connector 380 is communicated to the plug 370 through the passageways 366 in the sidewall 364 of the pressure adjustment mechanism 360 and through the passageways 372 in the plug to the inlet port 374. The biasing member 350 biases the piston 340 away from the plug 370, thereby permitting compressed gas from the inlet port 374 to travel into the receptacle 362. From the receptacle 362, compressed gas is communicated into piston 340 via the stem port 347 and through the gas transfer passageway 348 into the output area 316A of the piston chamber 316.

Compressed gas in the output area 316A of the piston chamber 316 flows into the expansion chamber 312 through the gas transfer passage 318. The compressed gas in the expansion chamber 312 and the output area 316A of the piston chamber 316 have an output pressure. The output pressure of the compressed gas in the output area 316A provides a force on the first surface 342 of the piston 340 to urge the piston towards the second position. Once the output pressure provides a sufficient force to overcome the biasing force of the biasing member 350, the piston 340 moves to the second position and the piston seal 349 seats against the inlet port seat 376 and seals off the inlet port 374, thereby preventing any further influx of compressed gas and maintaining the output pressure at the desired level. Adjustment of the pressure adjustment mechanism 360 adjusts the amount of biasing force applied on the piston 340 and thereby adjusts the desired level of the output pressure.

According to principles of the present invention, a compressed gas regulator is therefore provided which facilitates a connection to a compressed gas source to be arranged in a desired orientation. Other principles of the present invention provide an integrated expansion chamber and bleed valve in the regulator to facilitate a more reliable use of CO₂ as the compressed gas. Of course, various alternative embodiments are also contemplated. For instance, in non-CO₂ applications, the expansion chamber and bleed valve can be omitted entirely. Mechanical or pneumatic biasing members other than springs or spring packs could also be used.

Having described and illustrated various principles and aspects of the present invention through a detailed description of an exemplary embodiment thereof, it will be readily apparent to those skilled in the art that the embodiment disclosed can be modified in arrangement and detail without departing from the inventive principles made apparent herein. The claims should therefore be interpreted to cover all such variations and modifications.

What is claimed is:

1. A compressed gas regulator, comprising:
a body having an output port and a piston chamber communicating with the output port;
a piston arranged in the piston chamber, said piston having a first surface and a second surface, said piston further comprising a piston stem having a compressed gas transfer path arranged therethrough;
a biasing member arranged in the piston chamber and configured to apply a biasing force to the second surface of the piston to bias the piston towards a first position;
a piston seal arranged on an end of the piston stem to seal off an inlet port when the piston is arranged in a second position, wherein, in operation, compressed gas having an output pressure acts on the first surface of the piston to urge the piston towards the second position;
a pressure adjustment mechanism that enables adjustment of an amount of the biasing force applied to the second surface of the piston by the biasing member; and
an expansion area arranged in a fluid path between the piston chamber and the output port.

2. A regulator according to claim 1, farther comprising a bleed valve arranged in communication with a bottom of the expansion area.

3. A regulator according to claim 2, further comprising an exhaust port formed through a sidewall of the body to exhaust compressed gas or liquid CO₂ from the bleed valve.

4. A regulator according to claim 3, farther comprising a slot formed along an external surface of the regulator body in communication with the exhaust port to permit expansion of exhaust from the exhaust port.

5. A regulator according to claim 1, further comprising a swivel connector for connecting the regulator to a source of compressed gas.

6. A regulator according to claim 5, wherein the swivel connector surrounds a portion of the pressure adjustment mechanism and wherein compressed gas from the compressed gas source is supplied into the regulator through the swivel connector and then through one or more ports arranged through a sidewall of the pressure adjustment mechanism.

7. A regulator according to claim 6, further comprising a plug arranged in a first end of a chamber formed through the pressure adjustment mechanism, said plug comprising one or more compressed gas transfer passageways that communicate compressed gas from the one or more ports in the sidewall of the pressure adjustment mechanism to the inlet port.

8. A regulator according to claim 7, wherein the piston stem is matingly received in a second end of the chamber formed through the pressure adjustment mechanism, and wherein the piston seal on the end of the piston stem seals off the inlet port when the piston is arranged in the second position.

9. A regulator according to claim 1, further comprising a pressure relief port arranged through a sidewall of the regulator body in communication with the piston chamber and configured to exhaust compressed gas from the piston chamber when the output pressure exceeds a predetermined threshold.

10. A regulator according to claim 9, further comprising a slot arranged along an external surface of the regulator body in communication with the pressure relief port to permit expansion of the compressed gas exhausted from the pressure relief port.

11. A compressed gas regulator, comprising:
a body comprising an input end and an output end;
a connection mechanism arranged at the output end for connecting the output end to a pneumatic device;
an output port arranged in the output end of the body to supply compressed gas having an output pressure to the connected pneumatic device;
a piston chamber formed in the body with an output area arranged in communication with the output port;
a piston arranged in the piston chamber, said piston comprising a first surface, wherein compressed gas in the output area of the piston chamber having the output pressure supplies a force on the first surface of the piston to urge the piston towards a second position, said piston further comprising a second surface and a piston stem;
a biasing member arranged in the piston chamber and configured to supply a biasing force to the second surface to bias the piston towards a first position;
a pressure adjustment mechanism arranged in communication with the biasing member and configured to enable adjustment of an amount of the biasing force supplied by the biasing member to the second surface of the piston;
a receptacle arranged in a first end of the pressure adjustment mechanism, wherein the piston stem is slidingly arranged within the receptacle, said piston stem comprising a gas transfer passage configured to communicate compressed gas through the piston to the output area of the piston chamber;
a plug arranged in the receptacle, said plug comprising an inlet port and one or more gas transfer passageways;
a swivel connector arranged around a second end of the pressure adjustment mechanism, said swivel connector comprising a connector port for connecting to a supply of compressed gas having an input pressure, and wherein said pressure adjustment mechanism comprises one or more ports configured to receive compressed gas having the input pressure from the swivel connector and supply the compressed gas having the input pressure to the plug, and wherein the one or more gas transfer passageways in the plug convey compressed gas to the inlet port; and
a piston seal arranged on an end of the valve stem located within the receptacle, wherein said piston seal is configured to seal off the inlet port when the piston is arranged in the second position.

12. A regulator according to claim 11, further comprising an expansion chamber arranged in a fluid path between the output area of the piston chamber and the output port.

13. A regulator according to claim 12, further comprising a bleed valve arranged in communication with a bottom of the expansion chamber.

14. A regulator according to claim 13, further comprising an exhaust port arranged through a sidewall of the regulator body to release an exhaust from the bleed valve.

15. A regulator according to claim 14, further comprising a slot arranged along an external surface of the regulator body in communication with the exhaust port to permit safe release of the exhaust from the bleed valve.

16. A compressed gas regulator, comprising:
a body having an output port, an expansion chamber communicating with the output port, and a piston chamber communicating with the expansion chamber, wherein the piston chamber is configured to selectively receive compressed gas from an inlet port;
a piston slidably arranged within the piston chamber and configured to move between a first position and a second position, wherein when the piston is arranged in the second position, compressed gas is prevented from entering the piston chamber from the inlet port; and
a swivel connector configured to connect to a source of compressed gas and supply compressed gas from the compressed gas source to the inlet port.

17. A regulator according to claim 16, further comprising a bleed valve arranged in communication with the expansion chamber to release liquid CO₂ or excessive compressed gas from the expansion chamber.

18. A regulator according to claim 16, further comprising a pressure relief port arranged through the body of the regulator in communication with the piston chamber to release compressed gas from the piston chamber when the output pressure exceeds a predetermined threshold.

19. A regulator according to claim 16, further comprising a pressure adjustment mechanism configured to control the output pressure; and a plug arranged in the pressure adjustment mechanism, wherein said plug supplies the inlet port.

20. A regulator according to claim 19, wherein the pressure adjustment mechanism is arranged through the swivel connector, and wherein a stop ring is arranged in an end of the pressure adjustment mechanism to prevent over-travel of the plug and thereby prevent over-pressurization of the regulator.
